(19) United States
(12) Patent Application Publication
(10) Pub. No.: US 2008/0296428 A1
(43) Pub. Date: Dec. 4, 2008

(54) Air Freight Transport Method, Transport Aeroplane and Air Freight Transport System

(75) Inventor: Gert Joachim Reinhardt, Oetigheim (DE)

Correspondence Address: OHLANDT, GREELEY, RUGGIERO & PERLE, LLP, ONE LANDMARK SQUARE, 10TH FLOOR, STAMFORD, CT, 06901, US

(73) Assignee: Gaby Traute Reinhardt

(21) Appl. No.: 11/596,775

(22) PCT Filed: May 25, 2005
(86) PCT No.: PCT/EP05/52400

§ 371 Date: Nov. 15, 2007

(30) Foreign Application Priority Data
Jun. 2, 2004 (DE) 10 2004 026 816.9
Jul. 9, 2004 (DE) 10 2004 033 178.2

(51) Int. Cl. B64C 37/02

(52) U.S. Cl. 244/2

(57) ABSTRACT

An air cargo transportation method, a transport plane and an air cargo transport system. In the air cargo transportation method for the transport of various cargoes to different destinations, a transport plane is provided first that flies through at least three air regions respectively associated to a station. The transport plane does not land at one of the stations. Instead, the cargo is transported between the transport plane and one of the stations by an airworthy feeders, the cargo being transferred between the feeder and the transport plane while in the air. The transport plane and two feeders form the air cargo transport system, wherein the transport plane may comprise two interconnected feeders. With the air cargo transportation method, the utilization of the transport plane is enhanced. Further, the transport ways for individual cargo items can be shortened so that the efficiency is improved.

### BACKGROUND

1. Field

An air cargo transportation method, a transport plane and an air cargo transport system. The present disclosure refers to an air cargo transportation method for the transportation of various cargoes to different destinations. Further, the present disclosure is directed to a transport plane, as well as an air cargo transportation system, each suitable for transporting various cargoes to different destinations, the cargoes being objects and/or people.

2. Discussion of the Background Art

For transporting various cargoes to different destinations, it is known to use a transport plane with a corresponding transport capacity for the various cargoes. The transport plane is loaded at a starting location, takes off at this starting location and lands at a first destination for unloading. After unloading and, possibly, further loading, the transport plane takes off again and flies to a second destination. Having landed at the second destination, another loading and/or unloading occurs. The transport plane thus transports the loaded cargo to the respective next destination, where at least a part of the cargo is cleared.

In order to reduce clearing times for loading and unloading the trans-port plane, it is known from DE 199 14 939 A1 to pool cargo assigned to a certain destination in a particular cargo space so that for loading and unloading the transport plane, the respective cargo space is replaced with another cargo space. Loading and unloading individual package goods or passengers directly at the transport plane is thus avoided.

It is a drawback of the known air cargo transportation method that due to the necessarily great transport capacity of the transport plane, the transport plane is of relatively large design and can thus take off and land only at airports that are designed for planes of such large dimensions. Since, therefore, not any optional airport can be headed for, there is a great risk that the route of transport of a certain cargo to a certain final destination is rather long. Thus, due to the size of the transport plane, long hauls have to be accepted in transporting a certain cargo. Further, the fuel consumption is high and the down-time of the transport plane is long, so that the operating costs of the transport plane are high relative to the workload of the transport plane and the operation of the transport plane is not very economic.

### SUMMARY OF THE INVENTION

The present disclosure provides an air cargo transportation method, a transport plane and an air cargo transport system with which the transport of air cargoes to different destinations can be effected more economically, in particular without repeated reloading.

With the present air cargo transportation method, various cargoes are transported to different destinations, wherein the cargo may be objects and/or persons. First an air-borne flying transport plane is kept available which may also comprise a plurality of elements, each airworthy by itself, having a common direction of flight. The transport plane flies through at least three air areas that are each associated to a certain station. Further, the stations are associated to a destination for the various cargoes transported by the transport plane. According to the invention, the transport of the cargo from the transport plane to the station associated to the respective destination of the cargo is not effected through the transport plane's landing, but via airworthy feeders that start from a respective station and transport the cargo to the stations associated to the destination of the cargo. The airworthy feeders may additionally or alternatively also transport cargo from the respective station to the transport plane. The cargo transfer from the feeder to the transport plane and/or from the transport plane to the feeder takes place in the air. The respective feeder only carries those cargoes to the respective station that is associated to the destination of the respective cargo.

The feeders have a transport capacity which may in particular be less than that of the transport plane so that the feeders have a relatively low wing load. Moreover, the feeders, possibly a plurality thereof, can transport various cargoes for different destinations to the transport plane, the transport plane preferably consisting of a plurality of feeders. When transporting from a respective transport plane to a respective station, preferably only cargo having exactly one destination is transported, the destination being associated to the respective station to which the feeder flies. The air cargo transportation method of the invention allows to provide only exactly one take off and only exactly one landing procedure for each individual cargo item. Thus, repeated starting and landing with a certain cargo is avoided so that the fuel consumption of the transport plane is reduced. Further, lifting and landing the various cargoes is effected using the feeders, so that the transport plane needs not take off or land, thereby further reducing fuel consumption. In addition, due to their transport capacity, which in particular is smaller than that of the transport plane, the feeders can start from and land at airports not designed for the take off or landing of the transport plane. Thereby, it is possible to make the flight route scheduling of the transport plane more variable and, in particular, it can be fixed such that the transport ways and transport times can be shortened, respectively. The air cargo transport can thus be decentralized so that in particular large airports with a high traffic volume and corresponding long waiting times can be avoided. Using a physical transportation infrastructure, such as roads, rails, waterways, is avoided or at least significantly reduced. Further, the feeders employed may be, for example, helicopters or vertical take off planes that require particularly little space for taking off and landing, so that it is not necessary to provide the stations with airports and their accompanying extensive infrastructure. In particular when using helicopters or vertical take off planes as feeders, the take off and landing site of the feeder can be the same station so that the logistic effort is reduced.

The cargo is transferred between the feeder and the transport plane preferably by the feeder becoming a part of the transport plane, whereby reloading the cargo within the transport plane from one feeder to another can be avoided. The feeder and the transport plane thereby together form a common transport plane with an increased transport capacity. Thus, the cargo is transferred to the transport plane together with the feeder. To this avail, the feeder may be logically connected to the transport plane, e.g. through a common control by radio. Since the feeder thereby becomes an integral part of the transport plane, its function as a feeder is ended at least temporarily and will be resumed only when the feeder uncouples from the transport plane and no longer forms a part of the transport plane. Moreover, the feeder may be physically coupled, i.e. connected, to the transport plane through a flexible or rigid connection. In particular, the transport plane and the feeder may be of the same type of plane. The transport plane may thus be composed of a single feeder or a plurality of logically and/or physically connected feeders. For example, it is possible that a feeder that has been coupled to a trans-port plane made up by at least one feeder and thereby has become a part of the transport plane, itself forms the transport plane after the other parts of the transport plane have been uncoupled as feeders transporting cargo to a certain station. Thus, the integral structure of the transport plane is variable and may in particular be individually and flexibly adapted to the required transport volume. In the manner of a “trains able to fly”, the transport plane corresponds to a train and the feeders correspond to the individual wagons, requiring no elaborate infrastructure.

In a preferred embodiment, the transport plane is composed of at least two interconnected feeders. This means that the transport plane is formed only in the air by connecting two feeders. The number of interconnected feeders is chosen in particular with consideration to the expected required cargo capacity of the transport plane. In particular, the number is chosen automatically after each cargo transfer. Thus, it is possible to temporarily connect a feeder with the transport plane for loading or unloading so that the time required for loading or unloading does not or only slightly affect the transport time. In particular, it is possible to have the feeder start from a first station, possibly be connected with the transport plane for loading or unloading, and land at the next station. Especially when the feeder carries cargo that is associated to exactly one station, a logical connection between the feeder and the transport plane is sufficient, i.e. the combination of several feeders is effected by a single airplane crew by automatically transferring control commands to the other feeders. Thus, the transport plane or the group of feeders can be controlled with little effort.

As feeders, especially small planes with a low own weight are used, which substantially consist of a receptacle, especially a container corresponding to standards (standardized), which is connected to a propelling unit suitable for flying and/or to wings. The propelling unit may be propellers and/or jet engines that may be pivotable. Thus, a high payload is obtained at a low own weight and the required fuel volume is kept low. In particular, the size and/or the weight of the receptacle can be adapted to the cargo to be received. Moreover, no fuselage surrounding the receptacle is required.

According to an independent invention, the small plane is substantially composed of a receptacle, especially a container, connected to wings and/or a propelling unit. Preferably, the container is a standard container which may, for example, also be transported by ship, train or truck, and has the standard dimensions necessary for this purpose. The wings and/or the propelling unit are preferably removably or detachably connected with the container, e.g. through clamping, snapping or plug-in connections. Thus, the small plane is substantially designed as an “airworthy container” so that the technical features required for flight purposes can be reduced to a minimum, whereby the capital burden incurred by maintaining a vehicle fleet for the air transportation of goods is drastically reduced because of the less expensive technology, thereby improving upon the efficiency. Preferably, the small planes may be physically connected especially via the receptacle or container either in line, side by side and/or in stacked relationship. Preferably, the feeders are connected in line or side by side so that the thrust of the rearmost or outermost feeder can propel the feeders interconnected to form the transport plane. The feeders at front will be pushed forward, not pulled, so that rigid connections such as screw connections for a transfer of traction forces are not required and loose connections such as contacting thrust faces are sufficient as a physical connection.

Preferably, the transport plane flies along a defined route so that it is possible to head for the same stations in the same sequence several times. Due to the regular air traffic thus obtainable, one can also ensure the transport of a cargo that was not available at a respective station in time before take off of a feeder.

Especially if fuel for refueling or for the energy supply of the transport plane in the air is transferred during the transfer of cargo, refueling stops of the transport plane can be avoided, since the transport plane can be refueled while in air. This makes it possible to refuel the transport plane or the feeders forming the transport plane in a simple and economic manner using a single further light feeder. For exampie, it is possible that a single feeder of the transport plane provides electric power to supply electric motors of the other feeders through electric cables so that, for a “refueling” of the transport plane, only the feeder comprising the electric power supply has to be replaced. Preferably, the transport plane composed of a plurality of feeders comprises exactly one feeder that supplies power or fuel to the other feeders so that only this feeder has to be supplied with power or fuel to provide power or fuel to all feeders forming the transport plane. In particular, this allows to provide power generators and/or fuel tanks substantially only in this one feeder so that the fuel tank or the power storage means, such as batteries, of the other feeders may be considerably reduced. Especially, it is possible to provide only as much fuel or power in the other feeders as is required as braking power when landing so that the own weight of the other feeders is relatively low compared to the payload.

Moreover, the cargo can be sorted within the transport plane. Preferably, the cargo is sorted by the respective station to which the destination of the respective cargo is associated. Thereby, for example, several cargoes or parts thereof that have been transported to the transport plane from different starting locations may be combined to form a larger unit, such as a packing of larger volume, that is subsequently transported to the respective station by means of at least one feeder.

The invention further relates to a transport plane for the air transport of cargo, with which, in particular, the air cargo transportation method described above can be executed. According to the invention, the transport plane has a first feeder and a second feeder which are connected to form the transport plane. Preferably, the first feeder has a first wing and the second feeder has a second wing so that the two feeders are interconnected through a rigid connection of the first wing to the second wing. Moreover, the feeders, especially embodied by small planes, may be connected through cargo transport locks for the transport of cargo between the two feeders so that, in particular, it is possible to sort the cargo while in air. The cargo transport lock is located especially in the region of the rigid connection of the small planes so that, for example, cargo arranged in the wings can be exchanged in a simple manner. In particular, the cargo capacity of the transport plane can be adapted to the current transport volume through the number of feeders used to form the transport plane.

The invention further refers to an air cargo transport system for the air transportation of cargo, which is especially suitable for practicing the above air cargo transportation method. The air cargo transport system comprises a transport plane configured, in particular, as described before. Further, the air cargo transport system comprises a first feeder associated to a first station and a second feeder associated to a second station. According to the invention, the first feeder and the second feeder are adapted to be connected with the transport plane for the transfer of cargo. Connecting the feeders with the transport plane may be effected logically and/or physically for supply and/or cargo transfer purposes.

Using the present air cargo transport system, it is possible to improve upon the utilization time of the plane by reducing down times on the ground, thereby enhancing the transport of air cargo.

Preferably, the feeders have wings and/or at least one propelling unit which are arranged substantially vertical to the flying direction so as to be pivotable together and/or separately. In addition or alternatively, the length and/or the width of the wings may be variable.

In particular, the feeders take the form of small planes, i.e. the cargo is situated within the wings when transported. Preferably, the feeders comprise propelling units that allow for vertical movement. Thus, the feeders can be designed especially as vertical take off planes.

### BRIEF DESCRIPTION OF THE DRAWINGS

In the following the present disclosure will be described in more detail with reference to the accompanying drawings.

FIG. 1 is a schematic perspective view of an air cargo transport system according to a first embodiment,

FIG. 2 is a schematic perspective view of the air cargo transport system according to a second embodiment,

FIG. 3 is a schematic view of a transport plane of the present invention comprising a plurality of feeders,

FIG. 4 is a schematic perspective view of a connection between two wings in the air,

FIG. 5 is a schematic view of different connections between a plurality of simplified feeders to form a combined trans-port plane in the air,

FIG. 6 is a schematic view of a transport plane consisting of a plurality of feeders in the air, and

FIG. 7 is a schematic view of a feeder of the present invention transported on a truck.

### DETAILED DESCRIPTION OF THE PREFERRED EMBODIMENT

In the air cargo transportation method, the transport plane 10 may for example follow a substantially closed-loop flight route 12. The transport plane 10 flies through three air regions 14, 16, 18, each associated to a station 20, 22, 24 such as an airport. The stations 20, 22, 24 are associated to various destinations 26, 28, 30 to which various cargoes are to be transported. According to the invention, the transport plane 10 does not land at any of the stations 20, 22, 24. Instead, cargo is transported from one of the respective stations 20, 22, 24 to the transport plane 10 or from the transport plane 10 to the respective stations 20, 22, 24 using feeders 32. The transfer of cargo between the transport plane 10 and the feeder 32 occurs in the air regions 14, 16, 18 associated to the respective station 20, 22, 24.

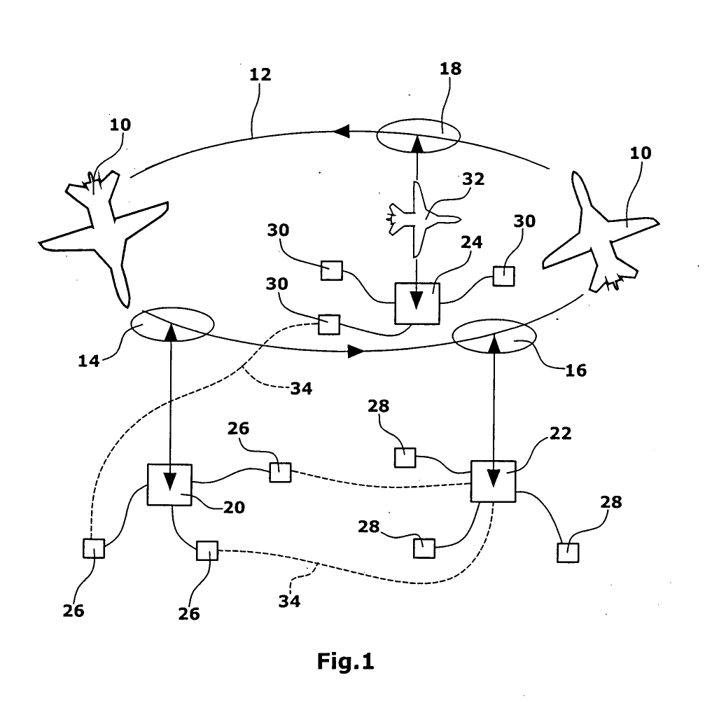

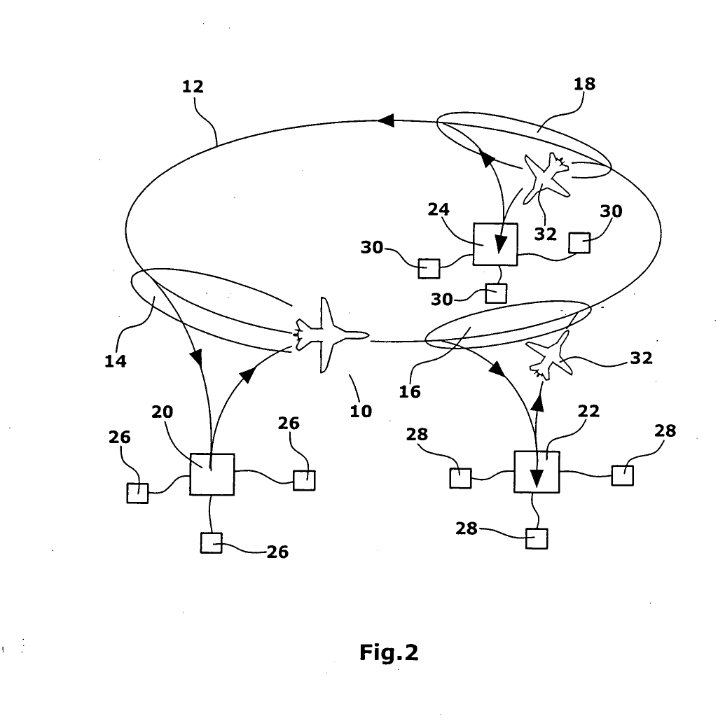

The feeder 32 may be a vertical take off plane, for example, so that the feeder 32 takes off and lands at the same station 20, 22, 24 (FIG. 1). The feeder 32 can possibly connect logically and/or physically with the transport plane 10 so that the feeder 32 becomes a part of the transport plane 10. In this case, the feeder 32 may take off and land at different stations 20, 22, 24 (FIG. 2).

The present air cargo transportation method allows to reduce the transport ways for individual cargo items. If, for example, station 20 is a small airport or another take off/landing airfield that cannot be headed for by the transport plane 10, the present air cargo transportation method offers the possibility to transport the cargo associated to the destinations 26 to the station 20 using the feeder 32 so that long transport ways 34 from a station 22 or 24 having a larger airport are avoided (FIG. 1).

A suitable transport plane 10 may be, for example, the “Lockheed Multibody Aircraft”, the “Lockheed Flatbed Aircraft”, the Boeing VLA, or the Boeing DLF. As feeders 32, small planes are especially suitable, for example following the “Oblique Flying Wing”, “Blended Wing”, or “Span Loader” concepts.

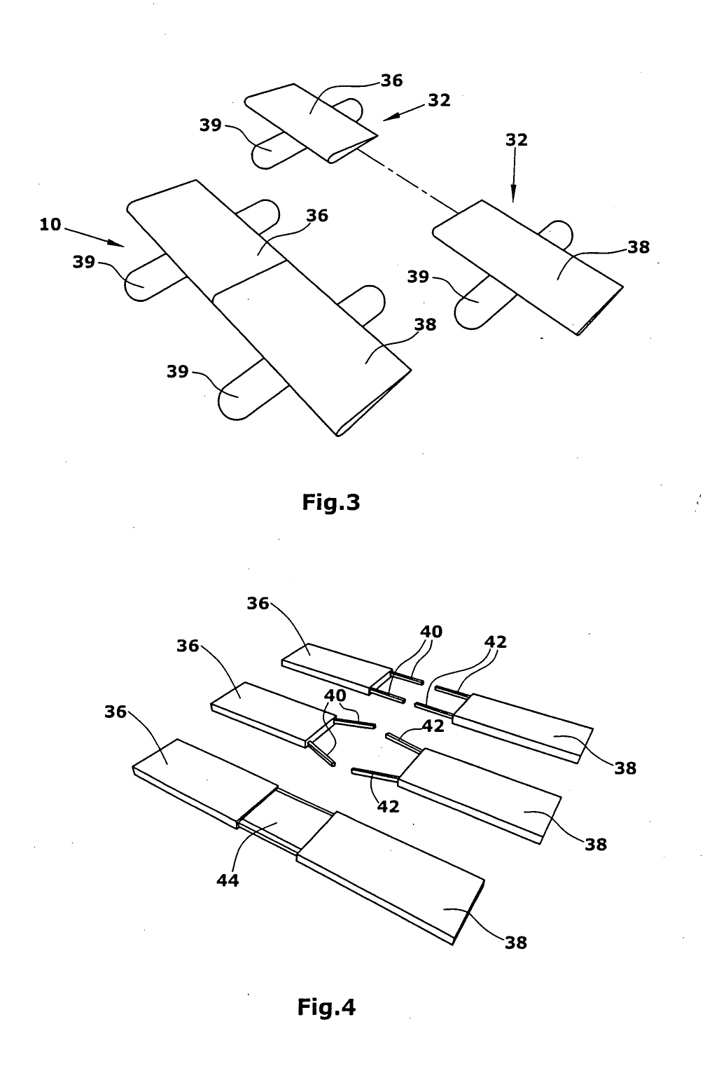

The feeders 32 can be connected in particular at their wings 36, 38 to from the transport plane 10 of the present invention (FIG. 3). Preferably, the feeders 32 are substantially composed of a receptacle 39, e.g., a container, connected with the wings 36, 38 and possibly with a propelling unit. In the event that a pilot flies the feeder 32, he may be positioned within the wings 36, 28. For the interconnection of the two wings 36, 38, the two feeders 32 are moved towards each other, in particular by an automatic control system, without the wings 36, 38 contacting first. The wings 36, 38 have connecting elements 40, 42, for example, that are extended from within the wings 36, 38 (FIG. 4). The connecting elements 40, 42 are then preferably spread apart so that, upon further approach, the two wings 36, 38 are centered on each other, especially automatically. Finally, a connecting piece 44 is extended from the first wing 36 and/or the second wing 38, which establishes a rigid connection between the wings 36, 38. In particular, the connecting piece 44 is designed as a cargo transport lock. If, for example, the feeder is of the “Span Loader” type, the transport of cargo between the transport spaces in the wings 36, 38 can thus be effected in a particularly simple manner.

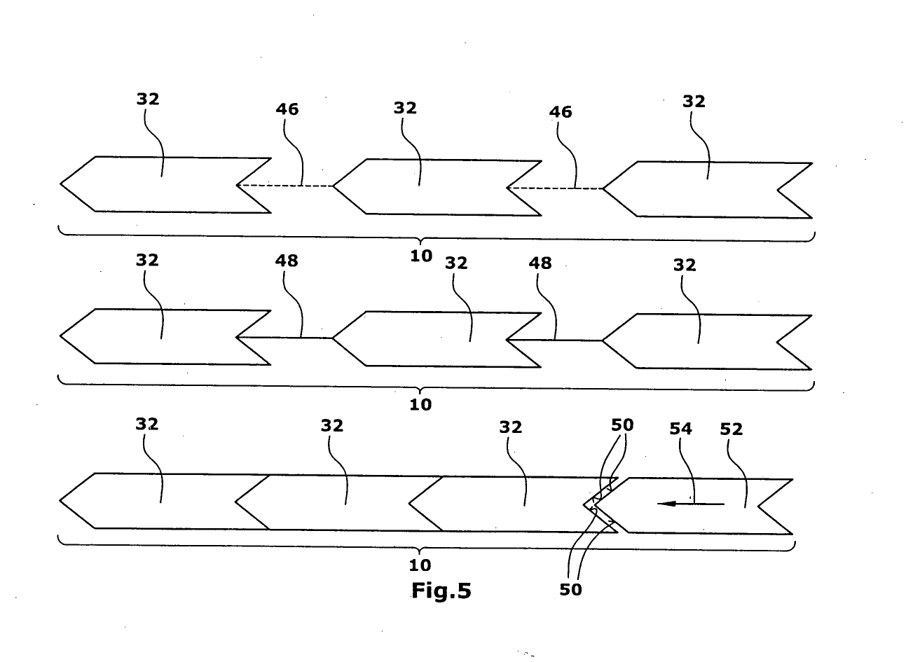

The transport plane 10 may be composed by several feeders 32 (FIG. 5). Should one feeder 32 fail due to technical problems, a failure of the entire transport plane 10 is thereby avoided. The individual feeders 32 may be connected through a logical connection 46, e.g., by radio. As an alternative, the individual feeders 32 may be interconnected via a flexible connection 48, e.g., hoses or cables. In this case, for example, fuel or small cargo items may be conveyed through the hoses. The individual feeders 32 may also be interconnected directly, e.g., by providing the individual feeders 32 with thrust faces 50 at which the individual feeders 32 abut. This allows the rearmost feeder 32 to provide propelling force in the direction of the arrow 54 through its thrust, which will hold the individual feeders 32, 52 together physically so as to form the transport plane 10. At the same time, it is possible to vary the combination of the individual feeders 32, 52 in the air and to thereby flexibly adapt to current requirements. Connecting and detaching the individual feeders is simpler when compared to a rigid connection.

Compared to a single large transport plane, the energy requirement of the present transport plane 10 composed of a plurality of feeders 32, 52 is reduced. At a payload of 150 t, known transport planes have an overall weight of 550 t, for example. To be able to transport 150 t of payload, a correspondingly strong structure of the transport plane and drives and wings of correspondingly large dimensions are required. Especially due to the large-sized wings and drives, high torsional moments occur at the fuselage of the transport plane that have to be compensated for by a correspondingly strong structure with additional components. Thus, known transport planes have a high own weight as compared to the payload. In contrast thereto, the feeders 32 have an overall weight of 15 t at a payload of 10 t, for example. Since the feeders 32 are of smaller size, they have to withstand lesser loads so that less expensive materials can be used to ensure the required strength. Further, compared to conventional transport planes, components can be omitted, whereby the own weight of the feeder 32 can be reduced further. Thus, the feeder 32 has a lower own weight relative to the payload. In the above example, 15 feeders 32 with a total weight of 225 t are required to transport 150 t of payload, so that, compared to conventional transport planes, the energy requirements of the present transport plane 10 are reduced. Moreover, the individual feeders 32 can be manufactured at low cost, so that the manufacturing costs of the present transport plane 10 are considerably reduced. Since the number of the feeders 32 used can be adapted to the required payload, transport costs can be further reduced.

With conventional transport planes, a plurality of individual fuselage parts are riveted, screwed, welded or glued together to form an assembled fuselage. Connected to this fuselage is a single pair of wings to which jet engines may be attached, for example. Compared to this, each fuselage element of the present transport plane 10 is airworthy by itself and, if at all, they are only loosely connected, e.g., via the thrust faces 50. Instead of achieving ever higher payloads with ever larger transport planes, thereby accepting an impaired payload/own weight ratio, the present transport plane 10 provides for a decentralized distribution of the payload, and thus the stresses, on a plurality of feeders 32, whereby the payload/own weight ratio is even improved. Moreover, the transport capacity provided may be varied almost randomly so that it is not the payload that is adjusted to the transport plane, but the transport plane 10 is adjusted to the payload. Thus, the volume of the payload is independent of the own weight of the transport plane 10.

The present transport plane 10 can thus also start from a rather small airport, since the individual elements of the transport plane 10 in the form of the individual feeders 32 can take off and land independently. After the individual feeders 32 have taken off separately from an airport, they can combine in the air to form a transport plane 10 of almost any desired size, for example, by being logically connected. To achieve this, for example, all feeders 32 are controlled or remote controlled from exactly one feeder 32 so as to form the present transport plane 10. As soon as the transport plane 10 has arrived at the destination, the individual elements of the transport plane 10 may each land on their own, by having each single feeder 32 land individually. Thus, it is possible that a plurality of feeders 32 take off at the same place and all feeders 32 land at the same place. This allows for a rather large transport plane 10 to take off and land at airports that would be too small for a conventional transport plane of comparable cargo capacity, since the take off and landing operations are carried out by elements using the feeders 32. Air cargo transportation by means of the present transport plane 10 may thus be effected more flexible and at lower cost.

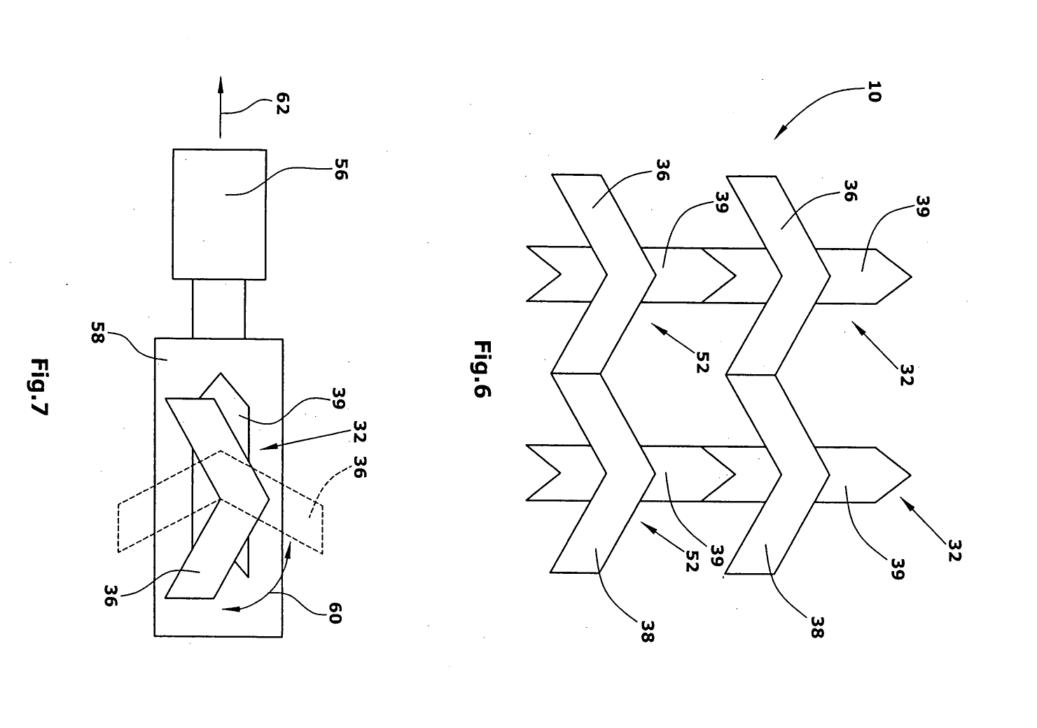

It is also possible to interconnect the individual feeders 32 of the transport plane 10 one behind the other via the containers 39, as well as side by side via the wings 36, 38 (FIG. 6). In this embodiment, the transport plane 10 formed by the feeders 32, 52 comprises several rearmost feeders 52, together providing the thrust required to trans-port the cargo. The propelling power of the transport plane 10 can thus be distributed among several rearmost feeders 52 that are chosen especially because of the quantity of fuel they carry.

Because of the small size of the present feeder 32, such a feeder 32 may be transported on a trailer 58 by means of a truck 56 (FIG. 7). Especially if the feeder 32 substantially is a conventional container 39 provided with wings 36, the feeder 32 is particularly easy to transport using a truck 56. In particular, it is possible to preassemble the wings 36, and possibly rotors or the like, of the feeder 32 and/or to make the wings 36 pivotable. Thus, it is possible, for example, to transport the feeder 32 on a highway using a truck 56 without the wings 36 protruding. For the take off of the feeder 32, the wings 36 may be pivoted to their flying position in the direction of the arrow 60. This allows a take off of the feeder 32 directly from the trailer 58 of the truck 56 without having to unload the feeder 32. Especially when the truck 56 moves in the direction of the arrow 62, a part of the take off energy of the feeder 32 is provided by the truck 56 so that the energy consumption of the feeder 32 is reduced. For example, the truck may accelerate from 0 to about 100 km/h in 25 seconds at which speed the feeder 32 is released from the trailer 58, whereby the feeder 32 can take off. For a landing of the feeder 32, the container may be separated from the wings 36 and the container falls down, possibly decelerated by means of parachutes or the like, so that less braking energy is required for the landing of the wings 36. Especially in the event of an accident can the container be separated from the wings 36 so that the systems thus formed will fall at a slower rate.

What is claimed is:

1. An air cargo transportation method for the transport of various cargoes to different destinations, comprising the following:
providing an air-borne transport plane,
flying through at least three air regions with the transport plane, each air region being associated to a respective station, and
transporting cargo from one of said respective stations to the transport plane and/or from the transport plane to the respective station using airworthy feeders,
the cargo being transferred from a feeder to the transport plane and/or from the transport plane to the feeder while in the air, and each feeder transports only those cargo items to a respective station associated to the destination of the cargo.

2. The air cargo transportation method of claim 1, wherein for the transfer of cargo, the feeder is logically and/or physically connected to the transport plane as a part of a combined transport plane.

3. The air cargo transportation method of claim 1, wherein the transport plane is composed of at least two interconnected feeders.

4. The air cargo transportation method of claim 3, wherein the number of the interconnected feeders is chosen with consideration to an expected required cargo capacity of the transport plane, the choice being made automatically in particular after each cargo transfer.

5. The air cargo transportation method of claim 1, wherein the transport plane flies along a defined route.

6. The air cargo transportation method of claim 1, wherein when transferring cargo, fuel is transferred for refueling the transport plane in the air.

7. The air cargo transportation method of claim 1, wherein the cargo is sorted within the transport plane according to the respective stations associated to a destination of the cargo.

8. The air cargo transportation method of claim 1, wherein small planes are used as the feeders.

9. A transport plane for the air transport of cargo comprising:
a first feeder and a second feeder,
the feeders being interconnected to form the transport plane.

10. The transport plane of claim 9, wherein the two feeders are connected via a cargo transport lock for transporting cargo between both feeders.

11. The transport plane of claim 9, wherein the first feeder has a first wing and the second feeder has a second wing, the first wing and the second wing being interconnected.

12. An air cargo transport system for the air transport of cargo comprising:
a transport plane,
a first feeder associated to a first station, and
a second feeder associated to a second station,
the first feeder and the second feeder being adapted to be connected with the transport plane or to form the transport plane for the transfer of cargo.

13. The air cargo transport system of claim 12, wherein the feeders have wings and/or propeller arranged so as to be pivotable with respect to the flying direction, and/or in that the length and/or the width of the wings is variable.

14. The air cargo transport system of claim 12, wherein the feeders have propellers that allow for a vertical movement.

15. The air cargo transport system of claim 12, wherein the feeders are small planes.

16. A feeder for an air cargo transportation method comprising:
a receptacle, and
wings connected with the receptacle and/or a propelling unit connected with the receptacles.

17. The feeder of claim 16, wherein the wings and/or the propelling unit are releasably connected to the receptacle.

18. (canceled)
